(19) United States
(12) Patent Application Publication
(10) Pub. No.: US 2015/0309713 A1
(43) Pub. Date: Oct. 29, 2015

(54) Method And Apparatus Of Displaying Data

(71) Applicant: TENCENT TECHNOLOGY (SHENZHEN) COMPANY LIMITED, Shenzhen City (CN)

(72) Inventors: Ying DONG, Shenzhen (CN); Yue HUANG, Shenzhen (CN); Ai LI, Shenzhen (CN)

(21) Appl. No.: 14/793,217

(22) Filed: Jul. 7, 2015

Related U.S. Application Data
(63) Continuation of application No. PCT/CN2014/070269, filed on Jan. 8, 2014.

(30) Foreign Application Priority Data
Jan. 15, 2013 (CN) 201310013886.9

(51) Int. Cl. G06F 3/0484; G06F 3/0486

(52) U.S. Cl. CPC G06F 3/04845; G06F 3/04847; G06F 3/04842; G06F 3/0486

(57) ABSTRACT

A method and an apparatus of displaying data is described. Target data is obtained and covered with at least one covering layer. The target data covered with the at least one covering layer is displayed. When a trigger event for removing the at least one covering layer is detected, the at least one covering layer is removed to reveal the target data.

### CROSS-REFERENCE TO RELATED APPLICATIONS

This application is a continuation of International Application No. PCT/CN2014/070269, filed Jan. 8, 2014. This application claims the benefit and priority of Chinese Application No. 201310013886.9, filed Jan. 15, 2013. The entire disclosures of each of the above applications are incorporated herein by reference.

### FIELD

The present disclosure relates to Internet technologies and to a method and an apparatus of displaying data.

### BACKGROUND

This section provides background information related to the present disclosure which is not necessarily prior art.

A scratch card is a small card, often made of a thin paper-based card for competitions and plastic to conceal information, where one or more areas contain concealed information which can be revealed by scratching off an opaque covering. Applications include cards sold for gambling (especially lottery games and quizzes), free-of-charge cards for quizzes, and to conceal confidential information such as PINs (Product Identification Numbers) for telephone calling cards and other prepaid services.

In the present disclosure, the concealed information contained in a scratchpad is also referred to as target information.

### SUMMARY

This section provides a general summary of the disclosure, and is not a comprehensive disclosure of its full scope or all of its features.

Various examples of the present disclosure provide a method and an apparatus of displaying data to simulate covering target data and removing the covering off of target data in a terminal device.

According to various embodiments, a method of displaying data may include:

obtaining target data;

covering the target data with at least one covering layer;

displaying the target data being covered by the at least one covering layer; and

removing the at least one covering layer to reveal the target data after a trigger event for removing the at least one covering layer is detected.

According to various embodiments, an apparatus of displaying data may include:

an obtaining module, configured to obtain target data;

a covering module, configured to cover the target data by using at least one covering layer;

a displaying module, configured to display the target data being covered by the at least one covering layer; and

a covering removing module, configured to remove the at least one covering layer to reveal the target data after a trigger event for removing the at least one covering layer is detected.

According to various embodiments, a terminal device of displaying data may include the above apparatus.

According to various embodiments, a system of displaying data may include a server and a terminal device;

the terminal device may include the above apparatus;

the server is configured to send the target data to the apparatus.

Various embodiments of the present disclosure simulate covering target data and removing the covering over the target data.

Further areas of applicability will become apparent from the description provided herein. The description and various examples in this summary are intended for purposes of illustration and are not intended to limit the scope of the present disclosure.

### DRAWINGS

The drawings described herein are for illustrative purposes of various embodiments and not all possible implementations, and are not intended to limit the scope of the present disclosure.

Features of the present disclosure are illustrated by way of example and are not limited in the following figures, in which like numerals indicate like elements.

FIG. 1 is a diagram illustrating a communication system according to various embodiments;

FIG. 2 is a diagram illustrating an example of a computing device according to various embodiments;

FIG. 3 is a flowchart illustrating a method according to various embodiments;

FIG. 4 is a diagram illustrating elements of a webpage according to various embodiments;

FIG. 5 is a diagram illustrating a webpage according to various embodiments;

FIG. 6 is a diagram illustrating a webpage according to various embodiments;

FIG. 7 is a flowchart illustrating a process of removing covering according to various embodiments;

FIG. 8 is a flowchart illustrating a process of removing covering according to various embodiments;

FIG. 9 is a block diagram illustrating modules of an apparatus according to various embodiments;

FIG. 10 is a block diagram illustrating modules of an apparatus according to various embodiments;

FIG. 11 to FIG. 14 are block diagrams illustrating units of a covering removing module according to various embodiments.

Corresponding reference numerals indicate corresponding parts throughout the several views of the drawings.

### DETAILED DESCRIPTION

Example embodiments will now be described more fully with reference to the accompanying drawings.

For simplicity and illustrative purposes, the present disclosure is described by referring mainly to an example thereof. In the following description, numerous details are set forth in order to provide a thorough understanding of the present disclosure. It will be readily apparent however, that the present disclosure may be practiced without limitation to these details. In other instances, some methods and structures have not been described in detail so as not to unnecessarily obscure the present disclosure. As used herein, the term “includes” means includes but not limited to, the term “including” means including but not limited to. The term “based on” means based at least in part on. Quantities of an element, unless specifically mentioned, may be one or a plurality of, or at least one.

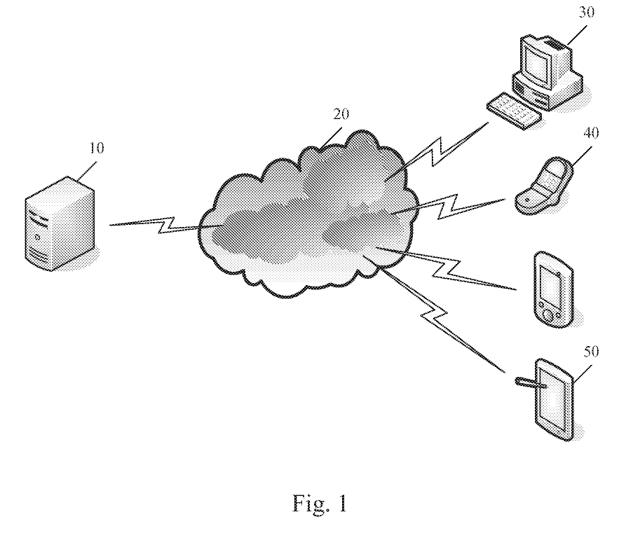

FIG. 1 is a diagram illustrating a communication system. As shown in FIG. 1, the communication system includes a server 10, a communication network 20, and user terminal devices. The user terminal device may be a personal computer (PC) 30, a mobile phone 40, a tablet computer 50, or other types of mobile Internet devices (MID), such as an electronic book reader, a handheld game console and etc. that can access the Internet using a certain wireless communication technology.

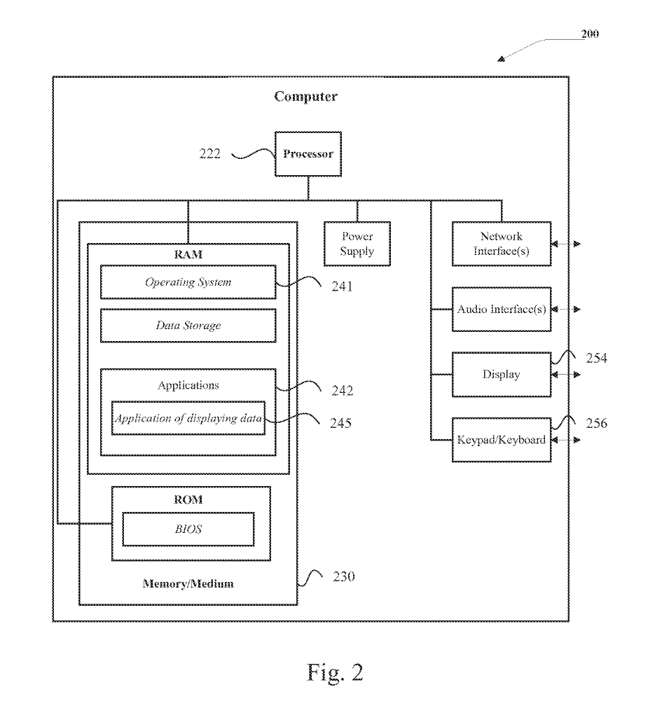

According to various embodiments of the present disclosure, the user terminal device may be a computing device that may execute methods and software systems. FIG. 2 is a diagram illustrating various embodiments of a computing device. As shown in FIG. 2, computing device 200 may be capable of executing a method and apparatus of the present disclosure. The computing device 200 may, for example, be a device such as a personal desktop computer or a portable device, such as a laptop computer, a tablet computer, a cellular telephone, or a smart phone. The computing device 200 may also be a server that connects to the above devices locally or via a network.

The computing device 200 may vary in terms of capabilities or features. Claimed subject matter is intended to cover a wide range of potential variations. For example, the computing device 200 may include a keypad/keyboard 256. It may also comprise a display 254, such as a liquid crystal display (LCD), or a display with a high degree of functionality, such as a touch-sensitive color 2D or 3D display. In contrast, however, as another example, a web-enabled computing device 200 may include one or more physical or virtual keyboards, and mass storage medium 230.

The computing device 200 may also include or may execute a variety of operating systems 241, including an operating system, such as a Windows™ or Linux™, or a mobile operating system, such as iOS™, Android™, or Windows Mobile™. The computing device 200 may include or run various applications 242. An application 242 is capable of implementing the method of displaying data of various embodiments of the present disclosure.

Further, the computing device 200 may include one or more non-transitory processor-readable storage medium 230 and one or multiple processors 222 in communication with the non-transitory processor-readable storage medium 230. For example, the non-transitory processor-readable storage medium 230 may be a RAM memory, flash memory, ROM memory, EPROM memory, EEPROM memory, registers, hard disk, a removable disk, a CD-ROM, or any other form of non-transitory storage medium known in the art. The one or more non-transitory processor-readable storage medium 230 may store sets of instructions, or units and/or modules that comprise the sets of instructions, for conducting operations described in the present disclosure. The one or multiple processors may be configured to execute the sets of instructions and perform the operations according to various embodiments of the present disclosure.

Various embodiments of the present disclosure implement virtual bearing of target data and simulate removing of covering of the target data to reveal the target data in a terminal device, so that the target data do not have to be borne on physical objects.

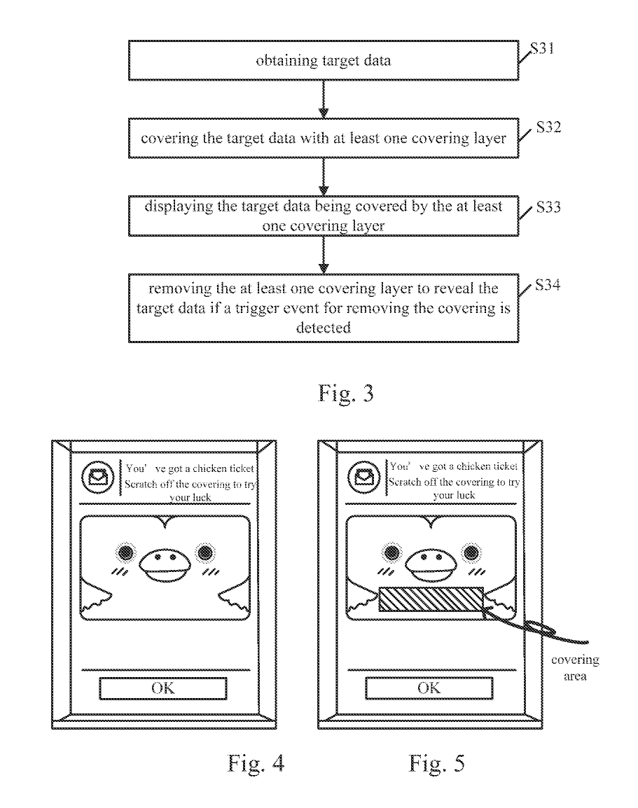

FIG. 3 is a flowchart illustrating a method according to various embodiments of the present disclosure. As shown in FIG. 3, the method may include the following procedures.

At block S31, target data, i.e., information that was concealed, is obtained. According to various embodiments, a request may be sent to a background server. After receiving the request, the background server may calculate the target data by using a pre-defined data processing algorithm, and return the target data obtained. Receiving the target data returned by the background server implements the procedure of obtaining the target data at block S31.

According to various embodiments, the target data returned may be encrypted to guarantee data safety. After the target data is received from the background server at block S31, the encrypted target data may be decrypted accordingly. The encryption and decryption may adopt existing algorithms, e.g., DES (Data Encryption Standard) or the like, and this is not limited in the present disclosure.

When the method is applied to lottery services, the data processing algorithm according to various embodiments may be an algorithm for calculating a probability of winning the lottery based on the amount of prizes, and the target data obtained from the algorithm may indicate winning a prize, not winning a prize, the type or the name of the prize, and the like. When the method is applied to prepaid services, the target data may be a PIN (Product/Personal Identification Number), or the like. When the method is applied to bankcard services, the target data may be a bankcard number, an initial password, or the like.

At block S32, the target data is covered with at least one covering layer. According to various embodiments, a canvas may be placed over the target data and serve as the covering layer. The canvas is opaque. According to various embodiments, at least two covering layers may be placed over the target data. Each of the covering layers may be opaque or partly opaque. According to various embodiments, each of the at least two covering layers covers part of the area, and the at least two covering layers may be placed in a pre-defined manner to make the target data completed concealed. The multiple covering layers may be arranged vertically or horizontally, and the manner is not limited in the present disclosure.

At block S33, the target data being covered by the at least one covering layer is displayed. According to various embodiments, when the method is implemented in a terminal device supporting web applications, the target data being covered by the at least one covering layer may be displayed in a webpage. A webpage may include various contents in addition to the target data being covered by the covering layer, e.g., other elements. Taking a lottery ticket as an example, FIG. 4 illustrates elements of a webpage.

Displaying the target data in a webpage may include defining a covering area being an area where the target data is displayed, initiating a command of loading elements other than the target data and the at least covering layer of the webpage, and displaying the target data being covered by the at least one covering layer together with the elements loaded. FIG. 5 illustrates a webpage including the covering area and other elements.

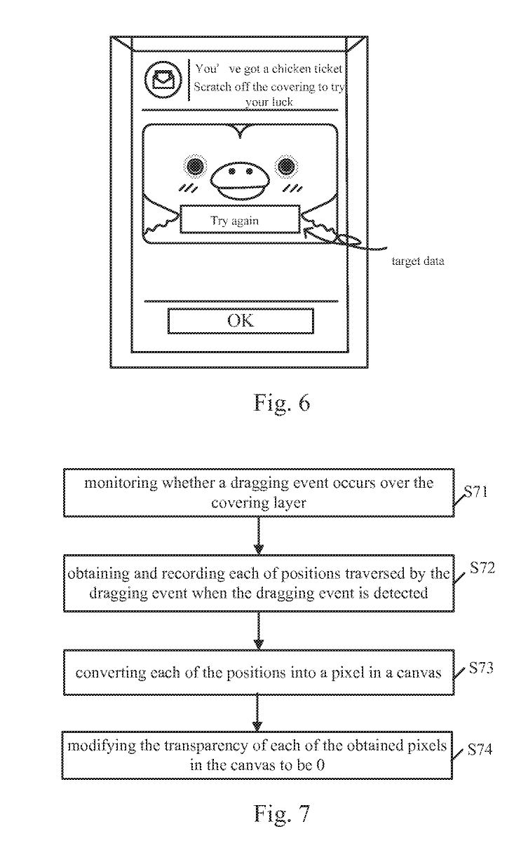

At block S34, the at least one covering layer is removed to reveal the target data after a trigger event for removing the at least one covering layer is detected. Taking a lottery application as an example, when the covering layer in the covering area is removed from the webpage as shown in FIG. 5 at block S34, the target data displayed may be as shown in FIG. 6. The process of removing the at least one covering layer in block S34 may be implemented through any of the following manners.

According to manner A, the process of removing the at least one covering layer may include the following procedures. In procedure A1, a “scratching” action performed on the covering layer is detected. The “scratching” action according to various embodiments is an imitation and simulation of a scratching action performed on a physical card for removing opaque covering. This procedure involves monitoring whether a pre-defined action occurs in a covering area where the at least one covering layer is placed. The pre-defined action, which is referred to herein as the “scratching” action, may be defined before the procedure in block S34 is performed, and functions for detecting the pre-defined action are also added to the apparatus or device implementing the method. The procedure A1 may determine that a pre-defined action occurs when an action satisfying a pre-defined condition is detected in real time.

In procedure A2, part of the at least one covering layer is removed according to a position, a gesture, and a speed of the action detected. For example, based on a “scratching” position, a “scratching” gesture and a “scratching” speed of the “scratching” action detected, the covering layer is removed bit by bit until the at least one covering layer over the target data is completely removed. For example, if the “scratching” gesture is moving up and down, scratches are displayed at positions where the “scratching” takes place at a speed consistent with the “scratching” speed until the covering layer is completely removed. In this example, the positions of the “scratching” is changing in real time until the covering layer is completely removed from the target data.

Manner B is mainly applied to a device having a pressure sensitive surface, and may present different removing effects for different strengths of “scratching” actions perceived. According to manner B, the process of removing the at least one covering layer may include the following procedures. In procedure B1, a pre-defined action, e.g., a simulated “scratching” action, is detected within a covering area wherein the at least one covering layer is placed. The procedure B1 is similar to the above procedure A1, and thus, is not described further.

In procedure B2, a length of to-be-removed part of the covering layer is determined according to the strength of the action. According to various embodiments, the length of the to-be-removed part of the covering layer may be determined by using the strength of the “scratching” action. If the strength is large, the part to be removed is also relatively larger in length, and vice versa. According to various embodiments, a relation between the strength of the action and the length of the to-be-removed part of the covering layer may be pre-defined to facilitate the determining of the length according to the strength. Thus, the length of the to-be-removed part of the covering layer can be determined by using the strength of the “scratching” action.

In procedure B3, part of the covering layer is removed in length based on the position where the action takes place, and the length of the part removed equals the length determined. For example, the covering layer is removed in length by the determined length based on the position where the “scratching” takes place until the covering layer is completed removed.

After the length of the part to be removed is determined, the covering layer is removed by the determined length based on the position where the action takes place in procedure B3. For example, the covering layer may be removed in length by the determined length starting from the position where the “scratching” action takes place or the covering layer may be removed in length by the determined length in a manner that a portion of the covering layer locating around a center is removed, and the center is the position where the action takes place. The position where the action takes place is changing in real time until the covering layer is removed completely from the target data.

According to manner C, the process of removing the covering layer may be as shown in FIG. 7. FIG. 7 is a flowchart illustrating a process of removing covering according to various embodiments of the present disclosure. This example takes the target data being covered by using a canvas, which serves as the covering layer. As shown in FIG. 7, the process may include the following procedures.

At block S71, a dragging event is detected in an area where the covering layer is placed. Before the procedure in block S71 is performed, functions of detecting a dragging event may be added to the apparatus implementing the method, and the dragging event is thus detected at block S71 by the functions added.

At block S72, each position traversed by the dragging event is obtained and recorded when the dragging event is detected. The dragging event is an event in which the position changes dynamically. Taking a touch device as an example, after it is detected that a user controlled mark, e.g., a finger or a cursor, has changed its position within the covering area, it is determined that a dragging event occurs and positions traversed by the dragging event are obtained and recorded. According to various embodiments, the terminal device may also be a device without a touch screen. The mechanism is similar to that described above, and thus, is not elaborated further herein. Since the dragging event occurs in the covering area, each position that is traversed by the dragging process recorded in block S72 is a position within the covering area.

At block S73, each of the recorded positions is converted into a pixel of the canvas. Since each of the positions recorded in block S72 is a position within the covering area, the procedure of block S73 converts each position in the covering area that is traversed in the dragging process into a pixel in the canvas.

At block S74, the transparency of each of the pixels obtained at block S73 is modified to be 0. Setting the transparency of a pixel in the canvas to be 0 has the same effect of removing the pixel in the covering layer from the covering area.

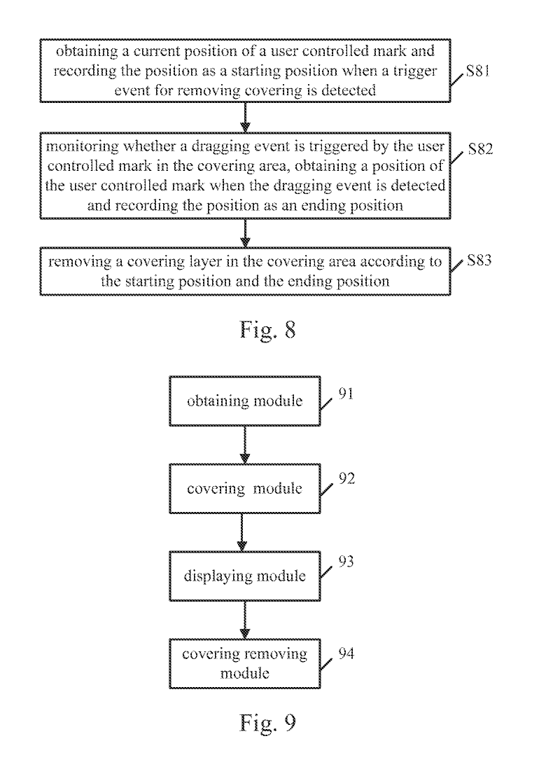

According to manner D, FIG. 8 is a flowchart illustrating a process of removing covering according to various embodiments of the present disclosure. This example takes the target data being covered by using at least two covering layers as an example. As shown in FIG. 8, the process may include the following procedures.

At block S81, when a trigger event for removing the covering layers is detected, a position of a user controlled mark, e.g., a finger or a cursor, is obtained and recorded as a starting position. According to various embodiments, when it is detected that a user controlled mark, e.g., a finger or a cursor, is placed in a covering area where the at least two covering layers are placed, it is determined that a trigger event for removing the covering layers is detected, and the current position of the user controlled mark is obtained and recorded as a starting position.

At block S82, a dragging event triggered by the user controlled mark in the covering area is detected and positions traversed by the user controlled mark during the dragging event are obtained and used for updating an ending position. According to various embodiments, when it is detected that the position of the user controlled mark, e.g., a finger or a cursor, changes in the covering area, it is determined that a dragging event in the covering area is initiated by the user controlled mark and a current position of the user controlled mark is obtained and recorded as the ending position.

At block S83, one of the covering layers in the covering area is removed according to the starting position and the ending position. According to various embodiments, the procedure in block S83 may include calculating a distance the dragging event has traversed in the covering area by using the starting position and the ending position, judging whether the distance is greater than a pre-defined threshold, removing the topmost covering layer among the at least two covering layers from the covering area if the distance is greater than the threshold, updating the starting position with the ending position, e.g., setting the value of the starting position to be the value of the ending position, and obtaining a different position of the user controlled mark in the covering area and recording the different position as the ending position if it is detected that the dragging event continues, and repeating the above removing process to remove the current topmost covering layer from the covering area.

In the above process, it may be judged whether there is still a covering layer over the target data and the removing process may continue if there is the covering layer, or the removing process is ended if there is no remaining covering layer.

According to various embodiments, the procedure in block S83 may include the following procedures.

Procedure I: A dragging distance traversed by the user controlled mark in the covering area is calculated by using the ending position and the starting position. It is judged whether the dragging distance is greater than a pre-defined threshold. A topmost covering layer over the target data is removed if the dragging distance is greater than the pre-defined threshold and procedure II is performed. Procedure III is performed if the dragging distance is not greater than the pre-defined threshold. According to various embodiments, the dragging distance may be calculated by calculating a difference between the ending position and the starting position, and taking the different obtained as the dragging distance traversed by the user controlled mark in the covering area.

The threshold in procedure I may be determined according the needs, e.g., may be a value indicating the sensitivity of the covering area.

Procedure II: It is determined whether there is a covering layer over the target data. Procedure III is performed if there is a covering layer over the target data, or the removing process is terminated if there is no covering layer.

Procedure III: The starting position is updated to be the starting position and a current position of the user controlled mark is obtained and recorded as the ending position if it is detected that the user controlled mark is still performing the dragging action and procedure I is performed.

Since the position of the user controlled mark is changing dynamically when the user controlled mark is performing a dragging action, the starting position is updated to be the ending position in procedure III, and the ending position is then updated by obtaining the current position of the user controlled mark which keeps on performing the dragging in the covering area. Procedure I is then performed and the process may be repeated until all of the covering layers in the covering area are removed.

In the process as shown in FIG. 7 or FIG. 8, the monitoring of dragging events in the covering area may not be performed at all times. According to various embodiments, the monitoring of dragging events in the covering area may be stopped dynamically to reduce resource consumption.

According to various embodiments, an ending event for terminating the removing process may be added for the covering area to dynamically terminate the monitoring of dragging events in the covering area. It may be monitored whether the ending event for terminating the removing process occurs. When an ending event is triggered by the user controlled mark, the monitoring of dragging events in the covering area is terminated.

Taking a touch device as an example of the terminal device, when it is detected that the user controlled mark leaves the covering area, it is determined that an ending event for terminating the removing process is triggered, and the monitoring of dragging events in the covering area is stopped.

According to the manners A, B, C, and D, an event for removing covering may be added in advance, and it is then monitored whether the trigger event for removing covering occurs. The event for removing covering may be pre-defined, e.g., in a touch device, it may be defined that when it is detected for the first time that a user controlled mark is placed in the covering area, it is determined that an event for removing covering occurs.

FIG. 9 is a block diagram illustrating modules of an apparatus according to various embodiments of the present disclosure. As shown in FIG. 9, the apparatus may include the following components. An obtaining module 91 obtains target data. A covering module 92 covers the target data by using at least one covering layer. A displaying module 93 displays the target data that is covered by the at least one covering layer. A covering removing module 94 removes the at least one covering layer to reveal the target data after a trigger event for removing covering is detected. According to various embodiments, the displaying module 93 may display the target data being covered by the covering layer in a web page.

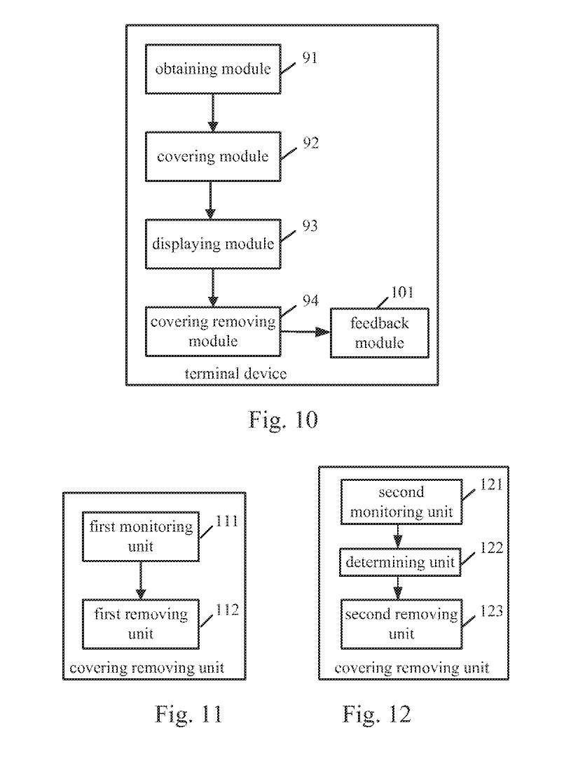

According to various embodiments, as shown in FIG. 10, the apparatus may also include a feedback module 101, which determines an identity of a covering layer after the covering layer is removed and provides a tactile feedback corresponding to the identity.

According to various embodiments, the covering removing module 94 may be implemented by any of the structures as shown in FIGS. 11, 12, 13, and 14.

As shown in FIG. 11, the covering removing module 94 may include a first monitoring unit 111 and a first removing unit 112. The first monitoring unit 111 may detect a pre-defined action, e.g., a simulated “scratching” operation, within a covering area wherein the at least one covering layer is placed.

The first removing unit 112 may remove part of the at least one covering layer according to a position, a gesture, and a speed of the action. For example, based on a “scratching” position, a “scratching” gesture and a “scratching” speed of the “scratching” action, the first removing unit 112 may remove the at least one covering layer bit by bit until the at least one covering layer is completely removed off the target data.

As shown in FIG. 12, the covering removing module 94 may include a second monitoring unit 121, a determining unit 122, and a second removing unit 123. The second monitoring unit 121 may detect a pre-defined action, e.g., a simulated “scratching” action, occurring within a covering area where the at least one covering layer is placed. The determining unit 122 may determine a length of a to-be-removed part of the at least one covering layer according to a strength of the action. The second removing unit 123 may remove a part of the at least one covering layer in length based on a position where the action takes place, and the length of the removed part equals the determined length. The second removing unit 123 may repeat the removing procedure according to actions detected by the second monitoring unit 121 until the at least one covering layer is completely removed off the target data.

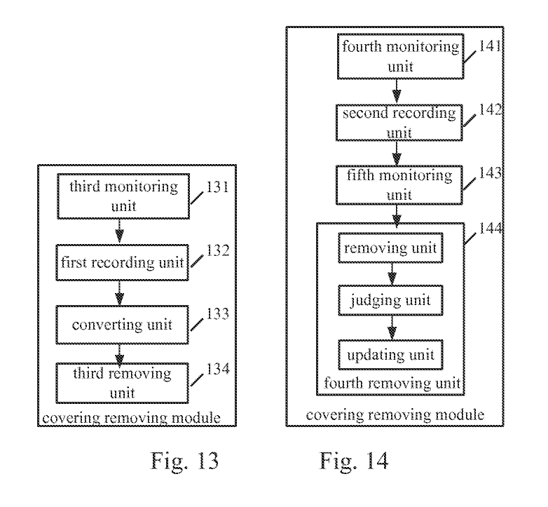

As shown in FIG. 13, the covering removing module 94 may include a third monitoring unit 131, a first recording unit 132, a converting unit 133, and a third removing unit 134. According to various embodiments, the displaying module 93 may place a canvas over the target data as the covering layer. The third monitoring unit 131 may detect a dragging event, which occurs over the covering layer. The first recording unit 132 may obtain and record each of positions that are traversed by the dragging event when the third monitoring unit 131 detects the dragging event. The converting unit 133 may convert each of the positions into a pixel in the canvas. The third removing unit 134 may modify the transparency of each of the pixels obtained by the converting unit 133 to be 0.

As shown in FIG. 14, the covering removing module 94 may include a fourth monitoring unit 141, a second recording unit 142, a fifth monitoring unit 143, and a fourth removing unit 144. According to various embodiments, the displaying module 93 may place at least two covering layers over the target data. The fourth monitoring unit 141 may detect a trigger event for removing covering initiated by a user controlled mark in a covering area where the at least one covering layer is placed.

The second recording unit 142 may obtain a position of the user controlled mark within the covering area and record the position as a starting position when the fourth monitoring unit 141 detects the trigger event obtain positions traversed by the user controlled mark during a dragging event when the fifth monitoring unit 143 detects the dragging event, and update an ending position with the positions. According to various embodiments, the second recording unit 142 may trigger the fourth removing unit 144 to perform a removing process each time when the end position is updated.

The fifth monitoring unit 143 may detect a dragging event triggered by the user controlled mark in the covering area.

The fourth removing unit 144 may remove a covering layer in the at least one covering layer in the covering area by using the starting position and the ending position. According to various embodiments, the fourth removing unit 144 may remove the covering layer in the covering area after receiving a trigger event from the second recording unit 142 by using the starting position and the ending position recorded by the second recording unit 142.

According to various embodiments, the fourth removing unit 144 may include:

a removing unit, which may calculate a dragging distance traversed by the user controlled mark in the covering area by using the starting position and the ending position recorded by the second recording unit 142, judge whether the dragging distance is greater than a pre-defined threshold, and remove the topmost covering layer over the target data if the dragging distance is greater than the pre-defined threshold;

an updating unit, which may update the starting position with the ending position recorded by the second recording unit 142.

According to various embodiments, the fourth removing unit 144 may include the following units.

A removing unit is capable of calculating a dragging distance traversed by the user controlled mark in the covering area by using the ending position and the starting position, judging whether the dragging distance is greater than a pre-defined threshold, removing the topmost covering layer over the target data, and sending a first instruction to a judging unit if the dragging distance is greater than the pre-defined threshold or sending a second instruction to the updating unit if the dragging distance is not greater than the pre-defined threshold.

The judging unit is capable of receiving the first instruction, judging whether there is a covering layer over the target data, and sending a third instruction to the updating unit if there is or terminating the removing process if there is not.

The updating unit is capable of updating the starting position with the ending position after receiving the second instruction or the third instruction, obtaining a position of the user controlled mark in the covering area when it is detected that the dragging event is going on, recording the position as the ending position in the second recording unit 142, and triggering the removing unit to perform the removing procedure.

Various examples also provide a terminal device of displaying data, which is capable of simulating the removing of covering over data. The terminal device includes the above apparatus, and will not be described further herein.

Various examples also provide a system of displaying data, which is capable of simulating removing of covering over data. The system may include a server and a terminal device. The terminal device includes the above apparatus. The server is capable of providing the target data for the apparatus.

Various embodiments cover target data with at least one covering layer, display the target data being covered, and remove the covering over the target data when a trigger event for removing the covering is detected to reveal the target data, thereby implementing simulated covering of target data on a virtual bearer in a terminal device and simulated removing of the covering over the target data.

In the above processes and structures, not all of the procedures and modules are necessary. Certain procedures or modules may be omitted according to certain requirements. The order of the procedures is not fixed, and can be adjusted according to the requirements. The modules are defined based on function simply for facilitating description. In implementation, a module may be implemented by multiple modules and functions of multiple modules may be implemented by the same module. The modules may reside in the same device or distribute in different devices. The “first”, “second” in the above descriptions are merely for distinguishing two similar objects, and have no substantial meanings.

According to various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module mechanically, in dedicated and permanently configured circuitry or in temporarily configured circuitry (e.g., configured by software), may be driven by cost and time considerations.

A machine-readable storage medium is also provided, which stores instructions to cause a machine to execute a method as described herein. A system or apparatus having a storage medium stores machine-readable program codes for implementing functions of any of the above examples and may make the system or the apparatus (or CPU or MPU) read and execute the program codes stored in the storage medium. In addition, instructions of the program codes may cause an operating system running in a computer to implement part or all of the operations. In addition, the program codes implemented from a storage medium are written in a storage device in an extension board inserted in the computer or in a storage in an extension unit connected to the computer. In this example, a CPU in the extension board or the extension unit executes at least part of the operations according to the instructions based on the program codes to realize the technical scheme of any of the above examples.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

The scope of the claims should not be limited by the various embodiments, but should be given the broadest interpretation consistent with the description as a whole.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method of displaying data, comprising:
obtaining target data;
covering the target data with at least one covering layer;
displaying the target data being covered by the at least one covering layer; and
removing the at least one covering layer to reveal the target data after a trigger event for removing the at least one covering layer is detected.

2. The method of claim 1, wherein the displaying the target data being covered by the at least one covering layer comprises:
displaying the target data being covered by the at least one covering layer in a webpage.

3. The method of claim 1, wherein the removing the at least one covering layer comprises:
removing part of the at least one covering layer when a pre-defined action is detected within a covering area where the at least one covering layer is placed according to a position, a gesture and a speed of the action.

4. The method of claim 1, wherein the removing the at least one covering layer comprises:
determining a length of a to-be-removed part of the at least one covering layer after a pre-defined action is detected in a covering area where the at least one covering layer is placed by using a strength of the pre-defined action; and
removing a part of the at least one covering layer in length based on a position where the action takes place, wherein the length of the part equals the length determined.

5. The method of claim 1, further comprising: after removing the at least one covering layer,
determining an identity of a covering layer that is removed; and
providing a tactile feedback corresponding to the identity.

6. The method of claim 1, wherein the covering the target data with at least one covering layer comprises:
placing a canvas over the target data as the covering layer.

7. The method of claim 6, wherein the removing the at least one covering layer comprises:
monitoring whether a dragging event occurs in a covering area where the at least one covering layer is placed;
obtaining and recording each of positions traversed by the dragging event when a dragging event is detected;
converting the positions into pixels in the canvas; and
modifying transparency of the pixels to be 0.

8. The method of claim 1, wherein the covering the target data with at least one covering layer comprises:
placing at least two covering layers over the target data.

9. The method of claim 8, wherein removing the at least one covering layer after a trigger event for removing the at least one covering layer is detected comprises:
monitoring whether a trigger event for removing the at least one covering layer is triggered by a user controlled mark in a covering area where the at least one covering layer is placed, obtaining a current position of the user controlled mark and recording the position as a starting position when a trigger event is detected;
monitoring whether a dragging event is triggered by the user controlled mark in the covering area, obtaining a second position traversed by the user controlled mark during the dragging event and updating an ending position with the second position; and
removing part of the at least two covering layers in the covering area according to the starting position and the ending position.

10. The method of claim 9, wherein the removing part of the at least two covering layers in the covering area according to the starting position and the ending position comprises:
calculating a distance traversed by the dragging event in the covering area by using the starting position and the ending position, judging whether the distance is greater than a pre-defined threshold, and removing a covering layer which is the topmost in remaining of the at least two covering layers over the target data if the distance is greater than the pre-defined threshold;
updating the starting position with the ending position, obtaining a third position of the user controlled mark in the covering area and recording the third position as the ending position when it is determined the dragging event continues, calculating a second distance traversed by the dragging event in the covering area by using the starting position and the ending position, judging whether the second distance is greater than the pre-defined threshold, and removing a second covering layer which is the topmost in remaining of the at least two covering layers off the target data if the second distance is greater than the pre-defined threshold.

11. An apparatus of displaying data, comprising:
an obtaining module, configured to obtain target data;
a covering adding module, configured to cover the target data by using at least one covering layer;
a displaying module, configured to display the target data being covered by the at least one covering layer; and
a covering removing module, configured to remove the at least one covering layer to reveal the target data after a trigger event for removing the at least one covering layer is detected.

12. The apparatus of claim 11, wherein the displaying unit is configured to display the target data being covered by the at least one covering layer in a webpage.

13. The apparatus of claim 11, wherein the covering removing module comprises:
a first monitoring unit, configured to detect a pre-defined action in a covering area where the at least one covering area is placed; and
a first removing unit, configured to remove part of the at least one covering layer according to a position, a gesture and a speed of the pre-defined action.

14. The apparatus of claim 11, wherein the covering removing module comprises:
a second monitoring unit, configured to detect that a pre-defined action takes place in a covering area where the at least one covering area is placed;
a determining unit, configured to determine a length of a to-be-removed part of the at least one covering layer according to a strength of the pre-defined action; and
a second removing unit, configured to remove a part of the at least one covering layer in length based on a position where the action takes place, wherein the length of the removed part equals the length determined by the determining unit.

15. The apparatus of claim 11, further comprising:
a feedback module, configured to determine an identity of a covering layer of the at least one covering layer after the covering layer is removed, and provides a tactile feedback corresponding to the identity.

16. The apparatus of claim 11, wherein the displaying module is configured to place a canvas over the target data as the at least one covering layer.

17. The apparatus of claim 16, wherein the covering removing module comprises:
a third monitoring unit, configured to detect a dragging event occurred in an area where the covering layer is placed;
a first recording unit, configured to obtain and record each of positions that are traversed by the dragging event when the third monitoring unit detects the dragging event;
a converting unit, configured to convert the positions into pixels in a canvas; and
a third removing unit, configured to modify the transparency of the pixels in the canvas into 0.

18. The apparatus of claim 11, wherein the displaying module is configured to place at least two covering layers over the target data.

19. The apparatus of claim 18, wherein the covering removing module comprises:
a fourth monitoring unit, configured to detect a trigger event for removing covering initiated by a user controlled mark in a covering area where the at least two covering layers are placed;
a second recording unit, configured to obtain a position of the user controlled mark within the covering area and record the position as a starting position when the fourth monitoring unit detects the trigger event; and obtain positions in the covering area traversed by the user controlled mark in a dragging event when a fifth monitoring unit detects the dragging event, and update an ending position with the positions;
the fifth monitoring unit, configured to detect the dragging event triggered by the user controlled mark in the covering area; and
a fourth removing unit, configured to remove part of the at least two covering layers by using the starting position and the ending position recorded by the second recording unit.

20. The apparatus of claim 19, wherein the fourth removing unit comprises:
a removing unit, which may calculate a dragging distance traversed by the user controlled mark in the covering area by using the starting position and the ending position recorded by the second recording unit, judge whether the dragging distance is greater than a pre-defined threshold, and remove the topmost covering layer over the target data if the dragging distance is greater than the pre-defined threshold; and
an updating unit, which may update the starting position with the ending position recorded by the second recording unit.
